(19) United States
(12) Patent Application Publication
(10) Pub. No.: US 2010/0262486 A1
(43) Pub. Date: Oct. 14, 2010

(54) Network Advertisement Transmission Device and Method

(76) Inventors: Hisashi Matsunaga, Tokyo (JP); Hideaki Haruta, Tokyo (JP); Hiroki Noda, Tokyo (JP)

Correspondence Address: SAMPSON & ASSOCIATES, P.C., 50 CONGRESS STREET, BOSTON, MA, 02109, US

(21) Appl. No.: 12/521,289

(22) PCT Filed: Dec. 27, 2007
(86) PCT No.: PCT/JP2007/001490

§ 371 Date: Jun. 16, 2010

(30) Foreign Application Priority Data
Dec. 27, 2006 (JP) 2006-353445

(51) Int. Cl. G06Q 30/00; G06Q 10/00; G06Q 50/00; H04N 7/10; G06F 17/30

(52) U.S. Cl. 705/14.43; 705/14.52; 705/14.61; 725/32; 707/802; 707/E17.044

(57) ABSTRACT

A technique of integrating advertisements through broadcasting with that through a network out of advertisement media and particularly a technique of producing high advertisement effectiveness by automatically synchronizing advertisement timing and by optimizing a display mode thereof is provided. A network advertisement transmitting device 10 connected to a user terminal device through a network and capable of transmitting advertisement data at the user terminal device is provided. The device 10 is provided with an advertisement-amount database 124 storing in storage means advertisement-amount information in which an information amount relating to at least either of the number of times and time for outputting the advertisement data is set for time and date for output and advertisement transmitting means 105 for transmitting the advertisement data to the user terminal device through the network according to the advertisement-amount information on the basis of current time obtained from clocking means.

### TECHNICAL FIELD

The present invention relates to a network advertisement transmission device and method connected to a user terminal device through a network and capable of transmitting advertisement data to be outputted in the user terminal device and particularly to a technique relating to a transmission pattern for transmitting the advertisement data.

### BACKGROUND ART

Technological innovation in the broadcasting communication field has been remarkable in recent years, and modes of television viewing in general households have been largely changed due to a wide spread of the Internet and switching to digital TV broadcasting. Particularly, provision of an access function to the Internet in a digital TV set and offering of products in which the digital TV set is integrated with a personal computer or video game have increased opportunities for users to use TV and the Internet at the same time.

When a commercial on a product is on TV, for example, a user who gets interested in the product searches its information on the Internet in many cases, and it is known that after the commercial, access to a web site of the product on the Internet is increased. Recently, access to a URL (Uniform Resource Locator) is promoted for users by presenting a specific URL during the commercial.

A trial to effectively integrate a broadcasting media including TV and a network including the Internet has been made. On the other hand, users spend a long time in using the Internet, with which the advertisement market on the Internet has rapidly expanded, and advertisers have positioned the Internet as one of important advertising media.

Selection of the advertising medium in general is designed such that the most effective advertising strategy can be used by combining various media as appropriate through an advertising agency. The advertising agency is demanded to make a proposal based on sophisticated information collection and know-how on how to combine which media at what ratio, how to distribute the advertising budget and the like in the Internet in addition to TV, radio, newspaper, and magazine on the basis of researches on various viewers and experiences.

Such an advertising strategy has been formulated on the basis of a system uniquely owned by the advertising agency, the experiences and hunches, and synergistic utilization of advertising media has been only made artificially in measures such as presentation of URL in the commercials as described above or notification of a period of newspaper advertisements in the commercial, for example.

However, by integrating both the advertisements on a more real-time basis in the coexistence of TV and the Internet as mentioned above, higher advertising effectiveness can be expected. Such a combination of media is also suggested in Non-Patent Document 1, for example.

Such a technique is relatively easy in a single Internet terminal and a single digital television, and some proposals have been already made. In the technique disclosed in Patent Document 1, for example, a system for providing information relating to contents broadcast in a program/CM desired by audiences by the same means in the program/CM in digital broadcasting is proposed. This technique discloses provision of commercial transaction means group including content information searching means for searching contents information recorded in a database relating to the program/CM contents from programs/CM being received and goods transaction means for making goods transaction by searching goods information recorded in the database relating to mail-order sale associated with the contents information obtained by the contents information searching means and homepage connecting means for connecting to a homepage with a homepage address set in the contents information.

Patent Document 2 pays attention to the fact that there are many banners not relating to the searched TV program in a search using EPG in digital broadcast, which does not attract interest of users, and discloses a technique in which needs of an advertising client matches needs of a user. For that purpose, an information acquisition method is provided such as an advertisement using the Internet in which a user connects to a relay server through the Internet from an Internet-ready terminal machine owned by the user, searches a program using an EPG function that enables reaching the information page of the desired TV program using a search function toward a deep layer from a top screen through the relay server, and pastes an advertisement such as a banner advertisement relating to the program in a display screen of the searched program information so that the information in the deep layer can be obtained sequentially by clicking the advertisement information.

Presentation of advertisements on Internet sites are known, and various systems and methods are provided, and Patent Document 3, for example, discloses a technique relating to transition to a WWW server of an advertiser from a banner advertisement.

### Citation List

Non-Patent Document 1: AD-Topic <Internet Advertisement>“System Reinforcement by Advertizing Companies in Reactivated Business—Combination with Mass Media as Key —” Business and Advertisement, April 2005

Patent Document 1: Japanese Patent Laid-Open No. 2002-290947

Patent Document 2: Japanese Patent Laid-Open No. 2002-245330

Patent Document 3: Japanese Patent Laid-Open No. 2003-141410

### SUMMARY OF INVENTION

The present invention was made in view of the above problems of the prior art and has an object to provide a technique to integrate advertisement through broadcasting with that through a network out of advertisement media and particularly a technique of producing high advertisement effectiveness by automatically synchronizing the advertisement timing and by optimizing a display mode.

In order to solve the above problems, the present invention uses the following means. The present invention is characterized in that in a network advertisement transmitting device connected to a user terminal device through a network and capable of transmitting advertisement data outputted at the user terminal device, the device is provided with an advertisement-amount database storing in storage means advertisement-amount information in which an information amount relating to at least either of the number of times and time for outputting the advertisement data is set for time and date for output and advertisement transmitting means for transmitting the advertisement data to the user terminal device through the network according to the advertisement-amount information on the basis of current time obtained from clocking means.

The network advertisement transmitting device may be configured to include a broadcast information database storing broadcast information relating to at least broadcast contents and broadcast time out of broadcast programs delivered on wired or wireless broadcast media intended to be directly received by the public in storage means, an advertisement condition database storing corresponding advertisement data and transmission conditions thereof in the storage means according to the broadcast contents, the transmission conditions including at least a condition relationship between the broadcast information and the current time, and advertisement transmitting means for transmitting the advertisement data from the advertisement condition database to the user terminal device through the network according to the advertisement-amount information if the current time obtained from the clocking means satisfies the transmission conditions.

In the network advertisement transmitting device, such a case may be included that the broadcast programs are broadcast shows of news, sports, performance, entertainment, discussion and the like.

If the broadcast program is a broadcast show, goods information extracting means for extracting information on a goods relating to goods or service from the broadcast contents of the broadcast show may be provided so that the extracted information is made as advertisement contents, the broadcast information at that time as advertisement information, and the broadcast information database at that time as an advertisement information database.

A case in which the broadcast program is an advertisement is included, and in that case, the broadcast contents may be advertisement contents, the broadcast information may be advertisement information, and the broadcast information database may be the advertisement information database.

The network advertisement transmitting device may be configured to be provided with an advertisement information database storing advertisement information relating to at least advertisement contents and issued dates out of advertisements placed on paper media including newspaper or magazine or advertisement media for the public including transport advertisements or outdoor advertisements in storage means, an advertisement condition database storing corresponding advertisement data and transmission conditions thereof in the storage means according to the advertisement contents, the transmission conditions including at least a condition relationship between the advertisement information and the current time, and advertisement transmitting means for transmitting the advertisement data from the advertisement condition database to the user terminal device through the network according to the advertisement-amount information if the current time obtained from the clocking means satisfies the transmission conditions.

The network advertisement transmitting device may handle any of output modes of two types or more of output modes in the user terminal device, two or more types of user terminal devices or two or more types of the networks, and the advertisement-amount information may be stored in the advertisement-amount database for each output mode with respect to the date for output.

The network advertisement transmitting device may be configured to be provided with user action acquisition means for acquiring user action information to the advertisement data, advertisement effectiveness determining means for determining effectiveness of the advertisement from the action information and the advertisement data, and advertisement-amount information setting means for setting the advertisement-amount information according to the determination result.

The network advertisement transmitting device may be configured to be provided with an advertisement-amount pattern database storing a plurality of patterns prepared in advance for the advertisement amounts with respect to the date for output in the storage means, in which the advertisement-amount information setting means selects anyone of the plurality of patterns and sets the advertisement-amount information according to the determination result of the advertisement effectiveness.

The advertisement-amount information setting means may be configured to set also the advertisement-amount information for mass media advertisements in at least any one of the broadcast media, paper media including newspaper or magazine or advertisement media for the public including transport advertisement or outdoor advertisement.

The broadcast media may be TV broadcast or radio broadcast.

The broadcast media may be at least either one of image or video delivery or sound delivery using a network communication path.

The advertisement data may be at least any one of text data, image data, video data or sound data constituting video advertisement, banner advertisement or text advertisement.

The network may be the Internet.

The network is a cellular phone line or PHS phone line and the user terminal device may be its phone terminal.

Also, the present invention can provide the following network advertisement transmitting method. That is, the method is a network advertisement transmitting method of a computer in a network advertisement transmitting device connected to a user terminal device through a network and capable of transmitting advertisement data outputted at the user terminal device, in which an advertisement-amount database is provided in advance storing in storage means advertisement-amount information in which an advertisement amount relating to at least either of the number of times or time for outputting the advertisement data is set for time and date for output and advertisement transmitting means of a computer may be configured to have an advertisement transmission step for transmitting the advertisement data to the user terminal device through the network according to the advertisement-amount information on the basis of the current time obtained from the clocking means.

In the network advertisement transmitting method of the computer, it may be configured such that a broadcast information database storing broadcast information relating to at least broadcast contents and broadcast time of the broadcast program delivered on the wired or wireless broadcast media intended to be directly received by the public in the storage means and an advertisement condition database storing the corresponding advertisement data and transmission conditions thereof in the storage means according to the broadcast contents are provided in advance, the transmission conditions including at least a condition relationship between the broadcast information and the current time, and in the advertisement transmission step, if the current time obtained from the clocking means satisfies the transmission condition, the advertisement data is transmitted to the user terminal device through the network from the advertisement condition database according to the advertisement-amount information.

Such a case may be included that the broadcast programs are broadcast shows of news, sports, performance, entertainment, discussion and the like. If the broadcast program is a broadcast show, a goods information extracting step in which goods information extracting means of a computer extracts information on goods relating to an article or service from the broadcast contents of the broadcast show may be provided before the advertisement transmission step, and the extracted information may be made as advertisement contents, the broadcast information at that time as advertisement information, and the broadcast information database at that time as an advertisement information database.

A case in which the broadcast program is an advertisement is included, and in that case, the broadcast contents may be advertisement contents, the broadcast information may be advertisement information, and the broadcast information database may be the advertisement information database.

The network advertisement transmitting method may be configured to be provided with an advertisement information database storing in storage means advertisement information relating to at least advertisement contents and issued dates out of advertisements placed on paper media including newspaper or magazine or advertisement media for the public including transport advertisements or outdoor advertisements and an advertisement condition database storing corresponding advertisement data and transmission conditions thereof in the storage means according to the advertisement contents, the transmission conditions including at least a condition relationship between the advertisement information and the current time, and in the advertisement transmission step, if the current time obtained from the clocking means satisfies the transmission conditions, the advertisement data is transmitted from the advertisement condition database to the user terminal device through the network according to the advertisement-amount information.

The network advertisement transmitting method may be configured to handle any of output modes of two types or more of output modes in the user terminal device, two or more types of user terminal devices or two or more types of the networks, and the advertisement-amount information is stored in the advertisement-amount database for each output mode with respect to the date for output.

The network advertisement transmitting method may be configured such that user action acquisition means of a computer has a user action acquisition step for acquiring user action information to the advertisement data, advertisement effectiveness determining means of a computer has an advertisement effectiveness determining step for determining effectiveness of the advertisement from the action information and the advertisement data, and advertisement-amount information setting means of a computer has an advertisement-amount information setting step for setting the advertisement-amount information according to the determination result.

In the network advertisement transmitting method, it may be so configured that an advertisement-amount pattern database is provided in advance storing a plurality of patterns prepared in advance for the advertisement amounts with respect to the date for output in the storage means, and in the advertisement-amount information setting step, the advertisement-amount information is set by selecting any one of the plurality of patterns according to the determination result of the advertisement effectiveness.

In the advertisement-amount information setting step, it may be so configured that the advertisement-amount information for mass media advertisements is also set in at least any one of the broadcast media, paper media including newspaper or magazine or advertisement media for the public including transport advertisement or outdoor advertisement.

The broadcast media may be TV broadcast or radio broadcast.

The broadcast media may be at least either one of image or video delivery or sound delivery using a network communication path.

The advertisement data may be at least any one of text data, image data, video data or sound data constituting video advertisement, banner advertisement or text advertisement.

The network may be the Internet.

The network is a cellular phone line or PHS phone line and the user terminal device may be its phone terminal.

Since the present invention is constituted as mentioned above, the following working effects are exerted. That is, the present invention provided with the advertisement-amount database can transmit network advertisement accurately on a specified date, specified number of output times or time and can transmit the advertisements surely to an intended target.

Particularly, by transmitting the advertisements in association with advertisement information in the broadcast media such as TV, radio, Internet delivery and the like and the mass media such as newspaper, magazine, transport advertisement and outdoor advertisements by a transmission condition using at least time, advertisement transmission in which plural media are integrated is realized, and contribution can be made to exertion of higher advertisement effectiveness.

Moreover, since the user action information to the transmitted advertisement data can be obtained on the network so as to determine the effectiveness of the advertisement, a required and sufficient amount of advertisement-amount information can be set and expected advertisement effectiveness can be obtained while an advertisement cost is suppressed.

By providing the advertisement-amount pattern database, an optimal pattern can be selected from existing advertisement placement patterns. As a result, transmission management on advertisement is facilitated, and specific targets can be narrowed.

The present invention can also set the advertisement-amount information in the existing media in addition to the network advertisements.

### DESCRIPTION OF EMBODIMENTS

An embodiment of the present invention will be described below referring to the attached drawings. FIG. 1A is an entire configuration diagram of a system (1) using a network advertisement transmitting device (this device) (10) according to the present invention. The advertisement transmitting device (10) is connected to the Internet (2), and a plurality of user terminal devices (3) (4) to which the advertisement is transmitted are connected to the Internet. A configuration of this network is as known.

The network of the present invention is not limited to the Internet, but arbitrary networks including a cable network in a limited area, a cellular phone network, a PHS network and the like can be used. The user terminal device takes a corresponding terminal configuration according to the type of the network. For example, if the network is the cellular phone network, the user terminal device is a cellular phone terminal, and a configuration to connect the cellular phone terminal to a unique network (“i-mode” (registered trademark) service provided by NTT DoCoMo Inc., for example) is known.

The present invention is to transmit an advertisement on the network as above and can be used only with the system in FIG. 1A but can be put into practice in combination with the advertisement in the broadcast media or paper media as follows.

FIG. 1B shows a system configuration of TV broadcast as an example of the broadcast media of the present invention. As shown in the figure, a TV signal (6) is transmitted by radio from a TV broadcast station (5), and a TV set (7) installed in a household receives it and outputs video (including sound. The same applies to the following). In the TV broadcasting, transition from analog broadcasting to digital broadcasting has progressed recently, and a transmitted TV signal has changed from an analog signal to a digital signal. In the case of the digital signal, various types of attached information is transmitted with video, and electronic program tables or attached advertisement information, weather information, traffic information and the like are also transmitted, for example.

As the broadcast media according to the present invention, media called mass media in general to be transmitted to the public in a wide range is suitable, and its typical example is TV broadcast and radio broadcast. The public directly receives it through TV sets or radio sets. Also, wired broadcast media such as cable TV, wired music broadcast and the like and broadcast media for delivering programs through the Internet can be used as the broadcast media.

The broadcast through the Internet is divided into the one for delivering programs at once and the other for delivering programs on demand according to an instruction from a user, and either of them are applicable. That is, since advertisement broadcast time contained in the advertisement information used in the present invention is a concept including not only the units of second, minute and hour but also certain periods of time such as the units of day, week and month, there is no problem even if the advertisement time gains/delays by the unit of second, minute or hour in accordance with the program time as long as the advertisement is sent during this period. In the Internet broadcast, delivery of image (including both moving images and still images) and sound is possible in addition to video delivery. The present invention can be used not only with the broadcast media but also the printed paper media such as newspaper and magazine or moreover the transport advertisement in trains, buses, stations and the like and outdoor advertisements by signboards or the like.

FIG. 2 shows a configuration diagram of the device (10). The device (10) is configured the most easily by a known personal computer and the following description will be made based on that. But an exclusive hardware may be used or the device may be incorporated as a part of a server device as will be described later.

In the device (10), as is known, hardware such as a CPU (100) for governing calculation processing, information processing and the like, a network adapter (110) for connection with the Internet (2), a hard disk (120) for storing various types of information such as a database, a monitor (130) for screen display, a keyboard (140) for receiving inputs from a user and the like as well as a memory (150) operating with the processing in the CPU (100) are provided.

The hard disk (120) is provided with an advertisement information database (hereinafter referred to as advertisement information DB) (121), an advertisement condition database (hereinafter referred to as advertisement condition DB) (122), and an advertisement-amount database (hereinafter referred to as advertisement-amount DB) (124). Contents of each database will be described later.

### First Embodiment

In the first embodiment of the present invention, a clocking portion (101) for clocking a current time by an oscillator built in the CPU (100) and an advertisement transmission portion (105) are provided. FIG. 3 shows a processing flowchart of the first embodiment. That is, from advertisement information according to TV commercials in the advertisement information DB (121), a transmission condition in the advertisement condition DB (122), and a current time obtained at the clocking portion (101), the advertisement transmission portion (105) determines if the transmission condition is satisfied or not (S10), and if satisfied, the advertisement-amount information of the advertisement-amount DB (124) is read out (S11), and the advertisement data is transmitted (S12) on the basis of it (advertisement transmission step). The advertisement information in the present invention refers to advertisement through the broadcast media, and the advertisement data refers to the advertisement in the network. In order to facilitate discrimination below, the advertisement information might be referred to as CM information and the advertisement contents as CM contents.

Each processing will be described below in detail. In the present invention, the CM information according to the CM contents and broadcast time is stored in advance in the advertisement information DB (121), which is an information table as shown in Table 1 as an example.

TABLE 1
CM information

| | | Broadcast | | |
|---|---|---|---|---|
| Advertiser | CM contents | station | Start time | End time |
| A company | Product A1 | X TV | Mon. 15:00:15 | Mon. 15:00:30 |
| A company | Product A2 | X TV | Mon. 15:30:30 | Mon. 15:30:45 |
| B company | Product B1 | TV Y | Mon. 14:55:00 | Mon. 14:55:30 |
| C company | Product C1 | X TV | Mon. 15:15:00 | Mon. 15:15:15 |
| C company | Product C2 | Z | Tue. 16:00:30 | Tue. 16:00:45 |
| | | broadcast | | |

That is, advertisers, CM contents (creative), broadcast station names which broadcast program, CM start time, and CM end time are recorded.

Subsequently, in the advertisement condition DB (122), the advertisement data and its transmission conditions are stored in advance, which is an information table as shown in Table 2 as an example.

TABLE 2
Transmission condition

| | Advertisement | Advertisement | Transmission | Transmission | Transmission |
|---|---|---|---|---|---|
| 1 | contents | data | start timing | end timing | destination |
| 2 | Product A1 | Banner data 1 | 30 seconds | 15 minutes | Banner |
| | | | after | after | advertisement |
| | | | advertisement | advertisement | region 1 |
| | | | end | end | |
| 3 | Product A1 | Banner data 2 | 15 minutes | 5 hours after | Banner |
| | | | after | advertisement | advertisement |
| | | | advertisement | end | region 2 |
| | | | end | | |
| 4 | Product A2 | Banner data 3 | 30 seconds | 15 minutes | Banner |
| | | | after | after | advertisement |
| | | | advertisement | advertisement | region 1 |
| | | | end | end | |
| 5 | Product A2 | Text data 1 | 15 minutes | 3 hours after | Text |
| | | | after | advertisement | advertisement |
| | | | advertisement | end | region 1 |
| | | | end | | |
| 6 | Product A2 | Streaming | At the same | Data length | Popup window |
| | | data 1 | time as | | |
| | | | advertisement | | |
| | | | end | | |

The contents in Table 2 will be described in detail. In the transmission condition, the CM contents, advertisement data, transmission start timing of the advertisement, the end timing of the same, and the transmission destination of the advertisement on the web page (site) are defined. FIG. 16 shows an example of a screen display (90) displayed using a web browser in the user terminal device.

For example, with regard to the product A1 on the second row, it is defined that the banner data 1 accumulated in the advertisement condition DB is displayed in the banner advertisement region 1 (900) on the site from 30 seconds after the CM ends to 15 minutes after. Combined with the information in Table 1, the data of the banner data 1 is displayed from 15:01:00 to 15:05:30 on Mondays.

Then, according to the transmission condition on the third row, the banner data 2 is displayed in the banner advertisement region 2 (901) from 15 minutes after the advertisement ends to 5 hours after. An advertising rate on the Internet web page is determined by display position, display size, display time, display frequency, achievements of click by users on the banner and the like in general, and the banner advertisement region 1 with the highest advertisement effectiveness is used immediately after the CM ends and then, the display is made in the banner advertisement region 2 for 5 hours. By defining the transmission condition as above, the advertisement mode on the web page can be changed in a complicated manner in collaboration with delivery of the CM.

Also, in the transmission condition on the fifth row, it is defined that the text advertisement for the product A2 is placed in the text advertisement region 1 (902). In the transmission condition on the sixth row, it is defined that video by the streaming data 1 is displayed on the popup window (new exclusive window is opened) (903). In this way, advertisement data in various data formats can be freely defined for the transmission conditions of the present invention.

The advertisement data itself does not have to be stored in the advertisement condition DB (122) but it may be so configured that the image files, video files, text files, sound files and the like are stored separately, and file names, directory names and the like indicating the storage locations are stored instead. Also, it may be so configured that the advertisement data itself is stored in another server device on the network such as a server device of the advertiser, for example, and its URL is stored as information of the advertisement data.

Together with the advertisement information and the transmission conditions as above, if the transmission condition is satisfied by the clocking result at the clocking portion (101), the advertisement-amount database (124) is referred to in the present invention and the advertisement is transmitted from the advertisement transmission portion (105) according to the advertisement-amount information contained therein.

Specific contents of the advertisement-amount information are data as shown in the following table 3.

TABLE 3

| Time | Monday | Tuesday | Wednesday | Thursday | Friday | Saturday | Sunday |
|---|---|---|---|---|---|---|---|
| 10-12 | 0 | 0 | 0 | 0 | 0 | 1 | 1 |
| 12-13 | 1 | 1 | 1 | 1 | 1 | 1 | 1 |
| 13-18 | 0 | 0 | 0 | 0 | 0 | 1 | 1 |
| 18-24 | 1 | 1 | 1 | 1 | 1 | 1 | 1 |

This table signifies if the advertisement is to be presented or not at each time or defines the number of times or time to present the advertisement, and it is defined, for example, that advertisement is not placed from 10 o'clock to 12 o'clock from Monday to Friday, placed from 12 o'clock to 13 o'clock, not placed from 13 o'clock to 18 o'clock and placed from 18 o'clock to 24 o'clock. Also, it is defined that the advertisement is placed in all the time zones.

By setting as above, it can be set such that the banner display is not to be placed in the morning of weekdays even if the transmission conditions are satisfied, for example. Alternatively, if the number of times or time to give advertisements is defined as the advertisement-amount information, by describing “3”, for example, in the above table, the banner advertisement sequentially displaying a plurality of advertisement by rotation can be defined such that the display frequency is tripled or the display time for one advertisement is tripled (“to 5 minutes after” in Table 2 is changed to “to 15 minutes after”). Alternatively, the time can be directly defined.

The advertisement data transmitted from the advertisement transmission portion (105) when the advertisement transmission portion (105) transmits the advertisement data to the user terminal device is transmitted from the network adapter (110) to the user terminal device under control of the communication portion (104). The advertisement data is outputted from the screen, a speaker and the like of the terminal.

In the above transmission conditions, the condition is shown as an example that transmission is made immediately after the end time of the CM or after a certain period of time has elapsed with the end time as a reference, but before or after the CM or the length of the time zone is arbitrary. For example, by increasing exposure of the advertisement on the Internet from 30 minutes before the CM and by giving the CM by each TV station when the interest of users making accesses is heightened, recognition by the users can be made certain.

Moreover, supposing that the broadcast media is broadcast on the Internet and the delivery period of the program is from Oct. 1 to Oct. 14, 2006. Then, the transmission conditions for a longer period may be defined such that the advertisement data is synchronized with that and the banner advertisement is displayed in the banner advertisement region 1 (900) at the transmission start timing from Oct. 1 to 14, 2006 and then, the banner advertisement is displayed in the banner advertisement region 2 (901) from Oct. 15 to 22.

There has been a case in which the advertisement by broadcast media such as TV and the advertisement on the network are placed manually at the same timing. According to the present invention, while transmission of the advertisement is automatically grasped by the advertisement information DB (121), appropriate advertisement data can be transmitted at appropriate timing according to complicated conditions defined by the transmission conditions. As a result, when users who took interest through the broadcast media access the Internet, the advertisement is displayed at a position with high visibility, and high advertisement effectiveness can be obtained. Moreover, by changing the advertisement position with time, the screen mode can bring about changes, and contribution can be made to reduction of advertising costs.

The present invention can be used in conjunction not only with the broadcast media such as TV and radio but also advertisement by paper media such as newspaper and magazine, advertizing media for the public such as transport advertisement, outdoor advertisements and the like. In the case of the paper media, setting is made by the unit of time longer than that of the broadcast media such as the unit of day for the newspaper and the unit of week/month for the magazines. For example, if an advertisement is placed on a morning paper on May 1, the transmission start timing is defined at 6 am on May 1 and the end timing at 6 am on May 4 in Table 2. Since a presentation period of the advertisement media for the public is also defined accurately, it can be used similarly to the paper media.

At this time, since the advertisement-amount information in the present invention is defined according to the behavior of a user on the Internet, by defining as in the above Table 3, the network advertisements can be effectively transmitted in a time zone when users can make an access the most easily even if the time unit in Table 2 is longer. The present invention does not necessarily have to be used in conjunction with the broadcast media or paper media but only the network advertisement may be transmitted on the basis of the advertisement-amount information. That is, the present invention may be configured only by the advertisement-amount information reading step (S11) and the advertisement information transmission step (S12) in FIG. 3.

### Second Embodiment

In addition to the above configuration, the advertisement-amount information may have different settings depending on the output mode in the user terminal device. The output modes relate to modes of output regarding in which of the plurality of advertisement regions in FIG. 16 the display is to be made, whether the type of data to be displayed is text or image and the like. In that case, the information as in Table 3 is defined for each output mode and presence, number of times, time and the like of the transmission are changed according to the mode when it is transmitted to the user terminal device.

Also, it may be set as the advertisement-amount information for each user terminal device. That is, a user terminal device identification portion, not shown, is provided in the device (10) so that the user terminal device is individually recognized and the advertisement-amount information is defined for each user terminal device or user terminal device group according to predetermined classification. For the identification of the user terminal devices, identification methods such as login using ID and password using a web browser or using cookie of the web browser as known is convenient.

Also, at search sites or mail order sites, for example, attributes (sex, age, address, occupation) and the like of the users are obtained in advance in general for convenience of offering of the service, and users may be classified on the basis of such information. According to the above configuration, the advertisement-amount information can be set according to each user such as the advertisement-amount information for a user A and the advertisement-amount information for a user B or as the advertisement-amount information for the female users in the twenties.

Moreover, the advertisement-amount information may be defined for each network. That is, the advertisement-amount information to be transmitted to the user terminal on the Internet and the advertisement-amount information to be transmitted to the user terminal of a cellular phone may be defined separately. By separating as above, the advertisement amount can be changed as appropriate according to ease of access by the user according to the network such as a commuting time zone for the cellular phone terminals and a lunch break or night for the Internet.

### Third Embodiment

In the present invention, the advertisement-amount information can be set according to an action from a user. Action information such as clicking on a banner, for example, to the advertisement data viewed by a user in the user terminal device is obtained. A processing flowchart of the present invention is shown in FIG. 4. First, a user action acquisition portion (108) is provided in the CPU (100), and a reaction by a user to the network advertisement is obtained as data (S20).

That is, as shown in FIG. 17, if the device (10) is a search site server device, suppose that a banner advertisement (911) of a car B, which is a new product of an A company, is displayed in the banner advertisement region 1. This banner advertisement is also displayed according to the transmission conditions and a listing condition as mentioned above. And if a user who viewed the CM accesses the search site (910) sees the banner advertisement and clicks it, for example, it is linked with a page (920) of the car B on a homepage of the A company as known.

Such a clicking action on a banner is one of user actions, and it is proposed in the present invention that the advertisement-amount DB (124) is set according to this user action (S21). First, processing of the user action acquisition portion (108) is described. A code to transmit a specific character string is added to the user action acquisition portion (108) of this server as a link of the banner advertisement, for example, so that the information is transmitted to the user action acquisition portion every time the user clicks the banner. That is, by specifying http://kensaku.dentsu.co.jp/search?p=(search word)&link?p=(link) as a link, (search word) can be notified to kensaku.dentsu.co.jp (this is made as an address of the user action acquisition portion) and at the same time, it is only necessary that a connection destination of the web browser is changed to the (link). Such a method is a known matter.

Moreover, the user action acquisition portion (108) may obtain information on what word is searched in the search site or information after having moved to the homepage of the advertiser (whether or not the product is purchased, a material is requested, viewed for 10 minutes, stopped watching immediately after that and the like). These can be obtained directly by the device through a known method or from the information from the connected server device.

Using this result, a click rate to 100 times of banner display can be obtained, for example. For example, as shown in FIG. 6, by calculating the click rate for all the days/time zones (600), the time zone with a setting not transmitting an advertisement even though the click rate is higher than a predetermined value in the advertisement-amount information before improvement (610) is changed to the advertisement-amount information after improvement (611).

By means of this configuration, by feeding back not only the predetermined advertisement-amount information but behaviors actually taken by users on the network, the optimal advertisement-amount information can be set. In order to obtain the user action accurately, it is preferable that individual user terminals are identified using known cookie so as to obtain information from each terminal. The acquisition of the user action in the present invention is not necessarily limited to the information that “an action was taken” but information that “an action was not taken” may be obtained, and it may be so configured, for example, that the banner advertisement is displayed in the banner advertisement region 1 for the first five times but if there is no action to access the link during that period, it is determined that the advertisement effectiveness is small and a change is made so that the advertisement is not transmitted.

Also, not only the click on the banner but a behavior history of the user in the search site may be obtained as a user action. For example, if facts that a search for a keyword relating to a car is made repeatedly on the search site or a video delivery of a car is viewed are recorded in user behavior history information (not shown) in the hard disk, the user action acquisition portion (108) reads them out. As a result, the banner can be presented in conjunction with the CM in a concentrated manner in a time zone when specific users can easily click on the banner.

For example, since a user who searched a movie A is highly likely interested in a sequel of the movie, the banner advertisement of the sequel can be displayed after the advertisement on the sequel is placed in CM even if the advertisement is not usually displayed in that time zone. Moreover, the banner advertisement of the sequel of the movie can be displayed after the CM of the sponsor company of the sequel, by which a synergetic effect between the advertisements can be exerted. In this way, the advertisement-amount information in the present invention contributes to setting for transmitting network advertisements to individual users or specific audiences the most effectively.

### Fourth Embodiment

In the present invention, the advertisement-amount information can be set by determining advertisement effectiveness. Here, a technique along with acquisition of the user action will be described in detail. FIG. 5 is a processing flowchart relating to this embodiment.

Subsequent to the user action acquisition step (S30), an advertisement effectiveness determination step (S31) is executed and processed. In the advertisement effectiveness determination portion (109) provided in the CPU, the advertisement effectiveness by the CM is calculated on the basis of the advertisement information DB (121). For the calculation, the following two effectiveness calculation modules are used. The modules are implemented in the advertisement effectiveness determination portion (109). One of them is a direct effectiveness calculation module, and inputted parameters include timing, day, time zone, broadcast station, audience rate, program genre, region and the like of the CM. It is information such as “October, beginning of the month, Friday, 5 pm, Fuji TV, news program, audience rate of 10%, Tokyo”, for example. The audience rate among them can be estimated from day, time zone and broadcast station by preparing past achieved audience rate data.

The direct effectiveness calculation module calculates a direct effect of the CM according to parameters when the CM is transmitted. A value indicating an effect is given to each parameter such that 0.6 to 5 pm and 0.7 to 6 pm for time zone and 0.5 to a news program and 0.8 to a variety program for program genre, for example, and after the parameters are given appropriate weighting, a direct effect value is obtained by a calculation equation to obtain the total value. For example, supposing that the weight of the audience rate is 10 and the other weights are 1, the direct effect value of a news program with the audience rate of 5% at 5 pm is 0.05×10×0.6×0.5=0.15, the direct effect value of a variety program with the audience rate of 10% at 6 pm is 0.10×10×0.7×0.8=0.56, and the direct effect value when the CM is given in the both programs is calculated as 0.71.

The other is a contact effectiveness calculation module, and inputted parameters include the accumulated number of past advertisements, GRP (which will be described later), advertisement reach (which will be described later), advertisement frequency (which will be described later), the respective periods and the like. For example, such a calculation can be made that “possibility of contact with the same advertisement five times in the past one month is 60%” from these parameters, for example. The calculation method will be described below in detail. And the contact effect value can be determined from a correspondence table set in advance such that the possibility of 5-time contact of 60% is 0.8 and that of 80% is 0.9. The explanation will be made below supposing that the contact effect value is 0.8.

The advertisement effectiveness determination portion (109) can calculate a value of the effect of the CM by totaling calculated values from the both modules, for example. In the above example, the value can be acquired as 0.71+0.8=1.51. In the present invention, the above parameters are preferably used, but its specific calculation method can be set as appropriate, and the above is only an example for explanation easily to be understood. In any case, by defining types of parameters and values according to the items and by substituting the values in a predetermined calculation equation, the advertisement effectiveness value can be obtained.

On the basis of the advertisement effectiveness value obtained as above, the advertisement amount in a specific time zone can be changed similarly to that shown in FIG. 6. At this time, it may be so configured that modification using the advertisement effectiveness value is made after improvement on the basis of the result at the user action acquisition step (S30), or the similar improvement is made by acquiring a comprehensive evaluation value from the evaluation value by the user action (the above click rate, for example) in advance and the advertisement effectiveness value using a predetermined calculation equation.

### Fifth Embodiment

Moreover, in the present invention, not only the advertisement-amount information of the network advertisements but also the advertisement-amount information of TV, radio, newspaper, magazine, transport advertisements, outdoor advertisements and the like can be outputted. In this configuration, placement of the advertisement is made manually, and the present invention is characterized by a point at which the advertisement information has been written on the hard disk. At that time, definition of the advertisement-amount information can be made according to predetermined patterns (referred to as patterns) as shown in FIG. 7.

In the case of the CM in TV, for example, there can be patterns such as a pattern of inverted L-shape (FIG. 7A) indicating that the advertisement is transmitted during night on weekdays and day and night of weekends, a pattern (FIG. 7B) of transmission in the same time zones and lunch breaks, a pattern (FIG. 7C) of transmission in the morning, noon, and night on weekdays and holidays, a pattern of transmission in the whole day, not shown, a pattern of transmission in the morning and night on weekdays and holidays and the like depending on targeted audiences. If the advertiser places an advertisement through an advertising agency, the above patterns are followed in many cases, and in the present invention, definition of the advertisement-amount information may be made according to the pattern by selecting the most appropriate pattern instead of defining the advertisement-amount information completely according to the time zone.

In this case, first, the advertisement amount is defined according to time zone as in FIG. 6 and then, an optimal pattern is selected by comparing it with a specific pattern. For example, supposing that the both patterns are matrices, a difference between the matrices is calculated and a pattern with the smallest difference is selected. The patterns as in FIG. 7 are stored in the hard disk in advance as the advertisement-amount pattern database according to the media.

And as shown in FIG. 8, a TV advertisement (801) forms an inverted L-shape, and a banner advertisement (802) is also an inverted L-shape as it is synchronized with the TV advertisement (801), but the advertisement is displayed by decreasing the frequency, for example, in all the time zones in the day in addition. Definitions according to the media can be made such that a newspaper advertisement (803) is placed on days of the month ending in 5 or 0 (when payments are often due) from January to November and all the days in December and a mobile (cellular phone) advertisement (804) in the lunch-break time zone in addition to the inverted L-shape.

### Sixth Embodiment

The present invention is configured as above, and the transmission conditions of the network advertisement, which is one of features of the present invention, will be described in detail. The CPU (100) shown in FIG. 2 is provided with the advertisement frequency estimation portion (102), and its estimation results are used for determining the transmission conditions.

First, the advertisement frequency will be described using FIG. 9. In advertising agencies, the advertisement frequency (frequency) is used as a parameter for measuring effectiveness of the advertisement. The advertisements may be intended for the public receiving the broadcast or may be intended for specific targets such as apart of the public, age, sex, occupation, position in the household (father, grandmother, children, grand-children and the like), social status and the like. An index indicating how many times the advertisement contents (creative) reach the entire public or a part thereof is the frequency.

The frequency can be searched using various methods, and an average frequency can be known by conducting a questionnaire such that “How many times have you seen the CM of the car B by the A company?” in an audience research. In the present invention, such research results may be stored in the hard disk (120) and used as they are.

However, a configuration in which the advertisement frequency estimation portion (102) executes and processes an advertisement frequency estimation step (S40) according to a processing flowchart shown in FIG. 9 will be described here. At the advertisement frequency estimation step (S40), information on the number of broadcasting times or broadcast time in the advertisement information DB (121) and the information on the audience rate researched separately are used. For example, as shown in FIG. 12, supposing that a man in the thirties does not view a program at 10 o'clock on Friday but views one at 11 o'clock and 12 o'clock, and the number of CM placement times of the car B by the A company is 0 times at 10 o'clock and 11 o'clock on Friday and 1 time at 12 o'clock, it means that the man views the CM once on Friday. By calculating similarly, the frequency of the CM by this man in this week results in 7.

Here, the example of a man belonging to a specific audience for a single channel in a limited time zone was exemplified, but since data according to specific audiences on information of the audience rates is offered by survey companies, the audience rate of a man in the thirties for a specific channel by time zone, for example, can be obtained. For example, if the audience rate of the man in the thirties at 12 o'clock on Friday is 3%, the frequency to the audiences is 1 and a proportion of the audiences is 3%, and then, the average frequency can be calculated as 0.03. The advertisement frequency estimation portion (102) can calculate the frequency of the CM for the car B by conducting the calculation processing on the basis of the advertisement information DB.

Regarding the meaning of the frequency, the following is known. That is, audiences do not fully recognize an advertisement if they have contact with the advertisement only once and an advertisement effect expected by the advertiser cannot be obtained. Herbert E. Krugman's Three-Hit Theory as a distinguished study is known, which says that the following reactions are found regarding repetition effect of an advertisement. First contact with advertisement->reaction as what it is, second contact with the advertisement->reaction as what is told about that, third contact with the advertisement->reaction to recall, fourth contact and after with the advertisement->repetition of the third reaction. That is, audiences are said to recognize the advertisement contents through at least three times of contact with the advertisement. However, since the number of three times is changed by various factors, that is a value which should be set appropriately depending on advertisement.

Particularly, it is known that the number of recognition times by contact with an advertisement is changed by the audiences, CM targeted products, types of campaign and the like, and a recognition times can be derived by means of calculation with a predetermined method based on a recognition times database defined separately in accordance with the audience, product, type of campaign and research results. In this device (10), such calculation processing can be executed. The effective contact with the advertisement as above can be confirmed by the frequency.

The higher frequency is not necessarily the better, and there can be a required minimum effective frequency (minimum effective frequency) for recognition and an effective frequency (maximum effective frequency) as an upper limit that will not tire the audience. These numbers of times can be defined in general such that the minimum effective frequency is 4 and the maximum effective frequency is 13, for example. Also, they might be determined manually on the basis of the research results on recognition rates and loss of interest in the CM conducted by a research company.

Calculations can be made on the basis of predetermined research results by various known calculation methods by the above minimum/maximum effective frequencies. The device (10) is provided with such a calculation processing function so that set values of effective frequencies can be changed for advertisement information of the processing target according to the audience, CM targeted product and the type of campaign.

In this embodiment, description is made using the relation between the frequency and the recognition number of times of advertisement, but various indexes for advertisement audiences can be used in addition to the recognition number of times. For example, the number of times till the contents (message) of the CM is understood or the number of times till an intension to purchase the product introduced in the CM is generated can be grasped in the relation with the frequency. These two indexes both have values larger than that of the recognition number of times but may be used in combination in the following transmission conditions such that all the plurality of indexes are satisfied or any of them is satisfied.

In the present invention, as the transmission conditions of the advertisement condition DB (122), conditions as in Table 4 can be added to the conditions in the first embodiment.

TABLE 4
Transmission conditions [frequency condition added]

| | | | | Transmission |
|---|---|---|---|---|
| 1 | Ad contents | Ad data | Ad frequency | position |
| 2 | Product A1 | Streaming | 0 to 4 | Popup window |
| | | data 1 | | |
| 3 | Product A1 | Banner data 1 | 5 to 13 | Banner ad |
| | | | | region 1 |
| 4 | Product A1 | None | 14 or more | (transmission |
| | | (transmission | | stopped) |
| | | stopped) | | |

According to Table 4, during time when recognition of the advertisement is important till the advertisement frequency reaches 4, the advertisement with the highest effectiveness is transmitted using a popup window, and with the frequency of 5 to 13 within the effective frequency, a banner advertisement is transmitted to the banner advertisement region 1. However, if the frequency exceeds 14, the advertisement contents have been already fully recognized by audiences, and further advertisement might have the opposite effect, and thus, the transmission is stopped.

The subsequent processing is similar to that of the first embodiment as shown in FIG. 6, in which the advertisement transmission portion (105) determines satisfaction of the transmission conditions (S41) and reads out the advertisement-amount information (S42) and then, executes the advertisement transmission step (S43). By incorporating the frequency in the transmission condition, the advertisement effectiveness can be further improved.

### Seventh Embodiment

In addition to the advertisement frequency described in the sixth embodiment, a parameter called advertisement reach can be added to the transmission condition. As a seventh embodiment, a configuration in which the CPU (100) shown in FIG. 2 is provided with an advertisement reach estimation portion (103) and its estimation result is used for determination of the transmission condition will be described.

The advertisement reach will be described using FIG. 16. In advertising agencies, advertisement reach (reach) is used as a parameter for measuring advertisement effectiveness. A proportion of people in contact with the advertisement contents (creative) in the people of the entire public or a part thereof is the reach.

The reach can be also researched by various methods, and an average reach can be known by conducting a questionnaire such that “Have you ever seen the CM of the car B by the A company?” in an audience research. In the present invention, such research results may also be stored in the hard disk (120) and used as they are.

Here, a configuration in which the advertisement reach estimation portion (103) executes and processes an advertisement reach estimation step (S51) after the above-mentioned advertisement frequency estimation step (S50) according to a processing flowchart shown in FIG. 10 will be described. The order of the advertisement frequency estimation step (S50) and the advertisement reach estimation step (S51) is arbitrary or may be simultaneous. In the advertisement reach estimation step (S51), information on the number of broadcast times and broadcast time in the advertisement information DB (121) and information on the audience rate separately researched are used.

As shown in FIG. 16, supposing that an audience rate of a part of an audience of the public (a man in the thirties) is 0% at 10 o'clock on Friday, 1% at 11 o'clock, and 3% at 12 o'clock, and the number of CM transmission times of the car B by the A company is 0 times, 0 times, and 1 time, it means that the reach at 12 o'clock on Friday is 3%.

Also, by multiplying the audience rate for each time zone by the CM transmission number of times and integrating them, the total reach can be calculated. The total reach is an index frequently used as indication of reach and represented by GRP (Gross Rating Point). Referring to the portion shown in FIG. 16 (Equation 1), 0%×0 times+1%×0 times+3%×1 time+3%×0 times+4%×1 time+5%×2 times+5%×2 times+5%×2 times+6%×2 times=49 GRP.

The advertisement reach estimation portion (103) of the present invention executes processing for calculating the advertisement reach by the above calculation. Here, as an embodiment of the present invention, the transmission conditions may be defined on the basis only of the advertisement reach. For example, the advertisement is defined to be transmitted when the advertisement reach is 5% or more so that the banner advertisement is displayed when many people come into contact with the advertisement. Alternatively, by using the total reach, it may be defined such that the advertisement is transmitted when GRP exceeds 1800.

In this embodiment, from the frequency by the advertisement frequency estimation step (S50) and the reach by the advertisement reach estimation step (S51), the reach distribution per frequency can be also obtained.

### Eighth Embodiment

In the seventh embodiment, the configuration using the frequency and the reach in combination or the configuration using only the reach is described. According to the combination of the former, the reach distribution per frequency can be obtained, and a method using the distribution as a transmission condition will be described later. Prior to that, a method of obtaining the reach distribution per frequency only by an action of the advertisement reach estimation portion (103) will be described in detail.

In this embodiment, as shown in FIG. 11, first, the CM broadcasting number of times/broadcast time and data of the audience rate in that time are inputted in the advertisement reach estimation portion (103) so as to obtain the reach distribution per frequency (advertisement reach estimation step: S60). A specific calculation method will be described using FIG. 11. First, using a man as a sample, probability that the man views the CM in a time zone A and a time zone B is acquired. This information can be obtained since presence of viewing in each time zone and each channel is contained by the unit of individuals in the audience rate data (it is well known that such audience rate data is distributed).

For example, if a man views the CM at 10 o'clock (time zone A) on Monday in the first week and does not view it in the same time zone in the second week, its probability is 50%. Similarly, if the man views it at 11 o'clock (time zone B) once in five weeks, the audience rate is 20%. The audience rate, here, is described as a probability of actually viewing the CM, but the media contact rate (probability of contact with media) and the advertisement attention rate (probability to actually pay attention to the advertisement in the people who had contact with the media) might be distinguished in general, and the audience rate may be a media contact rate or a probability (advertisement reach) obtained by multiplying the media contact rate by the advertisement attention rate.

For simplification of the explanation, only two time zones for a specific channel of a single sample will be explained, here, but actually, they all become plural parameters and a large amount of calculation processing is required. A unit of a time zone with a certain channel is called a unit in general, and the time zone A is called a unit A and the time zone B as a unit B, here.

First, the reach per unit is calculated (Step S60-1, S60-2). At this time, supposing that the CM is broadcast twice in the time zone A (800) and three times in the time zone B (801), the number of times that the CM reaches the man and its probability at that time can be calculated according to a known probability distribution model. As the probability distribution model, binominal distribution, Poisson distribution, normal distribution and the like are often used.

For example, if probabilities are distributed according to the binominal distribution, they can be calculated as follows, respectively. A probability P(r) based on the binominal distribution is expressed by an equation 2.

P(r)=ₙCᵣp^{r}(1−p)^{n-r} (Equation 2)

Here, the audience rate in the unit A is 0.5, and the audience rate in the unit B is 0.2, and then, p=0.5 and p=0.2, respectively. Also, since the CM is broadcast twice in the unit A and three times in the unit B, they are n=2 and n=3, respectively.

Then, for the unit A, O-times reach probability is ₂C₀×0.5⁰×(1−0.5)²=0.25, 1-time reach probability is ₂C₁×0.5¹×(1−0.5)¹=0.50, and 2-times reach probability is ₂C₂×0.5²×(1−0.5)⁰=0.25.

For the Unit B, 0-times reach probability is ₃C₀×0.2⁰×(1−0.2)³=0.512, 1-time reach probability is ₃C₁×0.2¹×(1−0.2)²=0.384, 2-times reach probability is ₃C₂×0.2²×(1−0.2)¹=0.096, and 3-times reach probability is ₃C₃×0.2³×(1−0.2)⁰=0.008.

Graphs illustrating the distribution of each frequency of each unit are graphs (802) (803) in FIG. 14. In order to combine the reach of each unit, by totaling the frequencies in each unit, the result is as shown in the following Table 5. The table indicates that if the reach is once in A and twice in B, the total is three times.

TABLE 5

B

| | Frequency | 0 | 1 | 2 | 3 |
|---|---|---|---|---|---|
| A | 0 | 0 | 1 | 2 | 3 |
| | 1 | 1 | 2 | 3 | 4 |
| | 2 | 2 | 3 | 4 | 5 |

If the distribution of the probabilities corresponding to Table 5 is acquired, the probability of 0 times in A is, for example, 0.25 from the above calculation and the probability of 0 times in B is 0.512, and then, 0.25×0.512=0.128. If all the calculations are carried out similarly, the distribution is as shown in Table 6.

TABLE 6

B

| | Frequency | 0 | 1 | 2 | 3 |
|---|---|---|---|---|---|
| A | 0 | 0.128 | 0.096 | 0.024 | 0.002 |
| | 1 | 0.256 | 0.192 | 0.048 | 0.004 |
| | 2 | 0.128 | 0.096 | 0.024 | 0.002 |

From the above table, the probability that the CM reaches the man 0 times is as 0.128, and the probability of reach once can be calculated as 0.096+0.256=0.352, which results in Table 7.

TABLE 7

| Advertisement frequency | Advertisement reach |
|---|---|
| 0 | 0.128 |
| 1 | 0.352 |
| 2 | 0.344 |
| 3 | 0.146 |
| 4 | 0.028 |
| 5 | 0.002 |

This is a step (S60-3) to obtain the advertisement reach distribution to a certain person by combining the reaches of plural units as above. Actually, by carrying out the above for a large number of sample people and taking an average value, the distributions of the advertisement frequency and advertisement reach in a certain period can be obtained.

For example, the 0 binominal distribution model by Metheringham can be used as a more sophisticated method. This model is widely used in order to obtain the frequency distribution and is known to be able to obtain accurate values with fewer parameters (See Non-Patent Document 2). Other than that, as the method for obtaining probability distribution in the present invention, known suitable techniques can be used as appropriate.

Non-Patent Document 2: Shigeru Kido, “Advertisement Management”, pp. 28 to 54, Asakura Shoten, May 15, 2004

A graph (804) of the distribution in Table 6 is shown in FIG. 14. Samples may be selected at random in order to express the entire public or the distribution of a part of the public such as female in the thirties or male college students, for example, may be obtained.

As mentioned above, from the methods in the sixth embodiment or in the seventh embodiment which can calculate accurate data more suitably or from direct research, the distributions of the frequency and reach can be obtained. A graph of the same kind as that of the graph (804) in FIG. 14 and closer to the actuality is shown in FIG. 15. Apart of data in FIG. 15 is shown in Table 8.

TABLE 8

| Frequency X | X-times reach | X-times or more reach |
|---|---|---|
| 1 | 4.0% | 98.0% |
| 2 | 4.5% | 94.0% |
| 3 | 5.0% | 89.5% |

By calculating the reach x-times or more as in Table 8, indexes of advertisement effectiveness more precise than the advertisement frequency in the second embodiment can be obtained such that those who saw the advertisement once or more is 98% and twice or more is 94%, for example.

In the advertisement frequency in FIG. 15, if 4 times to 11 times (a painted portion in the graph) are effective advertisement frequencies, the target the advertisement reached is the target which the advertisement contents effectively reach. The total of the advertisement reach in this number of times region is called effective advertisement reach (effective reach).

In this embodiment, the effective advertisement reach is defined as the transmission condition as in Table 9.

TABLE 9
Transmission condition (effective advertisement
reach condition added)

| | | | Effective ad | Transmission |
|---|---|---|---|---|
| 1 | Ad contents | Ad data | reach | position |
| 2 | Product A1 | Streaming | 60% or more | Popup window |
| | | data 1 | | |
| 3 | Product A1 | Banner data 1 | 30 to 60% | Banner ad |
| | | | | region 1 |
| 4 | Product A1 | Text data 1 | 30% or less | Text ad |
| | | | | region 1 |

Similarly to the first embodiment, if the advertisement transmission portion (105) determines that the transmission condition is satisfied (S52) (S61), the advertisement-amount information is read out (S53) (S62), and the advertisement data is transmitted at the advertisement transmission step (S54) (S63).

### Ninth Embodiment

The case in which the broadcast program is the advertisement is explained in the above embodiment, but the present invention can be intended for any broadcast show such as news, information program, variety program, quiz show, sport program and the like. First, the program contents are extracted from the database of the program contents such as an electronic program table. Then, suppose that the following broadcast information database is provided, for example.

TABLE 10
Broadcast information

| Broadcast | Broadcast | Broadcast | | |
|---|---|---|---|---|
| show | contents | station | Start time | End time |
| News A | Hybrid car on | X TV | 12/1 | 12/1 |
| | the rise | | 15:00:00 | 15:30:00 |

That is, in the news A, news with the contents that the number of hybrid car registrations is on the rise is broadcast, and the time is from 15:00 to 15:30 on December 1 is recorded.

After such news is broadcast, consumers' interest in the hybrid cars is heightened, and it is preferable to transmit the advertisement immediately after that. Therefore, by providing the following transmission condition, for example, the advertisement can be transmitted.

TABLE 11
Transmission condition

| Keyword | | | | |
|---|---|---|---|---|
| contained in | | | | |
| the broadcast | | Transmission | Transmission | Transmission |
| contents | Ad data | start timing | end timing | position |
| Hybrid car | Banner data | Simultaneously | 1 hour after | Banner ad |
| | 1 | with broadcast | the | region 1 |
| | | start | broadcast | |
| | | | end | |

According to the above transmission condition, the transmission condition is determined by detecting that the keyword of the “hybrid car” is included by a known character string search technique, morphological analysis technique and the like from the broadcast contents of “hybrid car on the rise”, and like banner data 1 is transmitted to the banner advertisement region 1 simultaneously with the broadcast start.

### Tenth Embodiment

Moreover, even for the advertisements not included in the broadcast contents in the electronic program table, information on the goods relating to the goods and service can be extracted from the broadcast contents by providing an information extraction portion, not shown, in the CPU (100). That is, the information extraction portion refers to a goods information database, not shown, in the hard disk (120), determines that the information relates to a specific advertiser's goods from the broadcast contents, and can uses it as the advertisement contents of the above embodiment. For example, the following goods information database is provided.

TABLE 12
Goods information database

| Keyword contained in | |
|---|---|
| the broadcast contents | Advertisement contents |
| Car | Car A1 by A company |
| | Car inspection service B1 by B company |
| Metabolic | Salad oil C1 by C company |

If the “car” is contained in the broadcast contents, processing similar to the case in which advertisements of “car A1 by A company” and “car inspection service B1 by B company” are broadcast is executed. In this way, one broadcast may include two or more advertisement contents, or one for “metabolic” and one for “salad oil C1 by C company” may be defined, and setting can be made appropriately, giving consideration to advertisement effectiveness.

In the goods information database, the goods to be associated with the broadcast contents may be a name of a specific goods or a company name dealing with the goods. For example, instead of the salad oil C1 by the C company, it may be the mere business advertisement of the C company. Alternatively, it may be the advertisement of all the products handled by the C company.

As the broadcast program, the advertisement and the broadcast show may be both included in the configuration. That is, if the “car” is contained in the broadcast contents and the “car A1” is broadcast in the inserted CM, since the car is taken up in the program and also in the CM, viewers' interest has been increased, and transmission of the advertisement data of the car at this timing exerts synergetic effects.

The configuration of the present invention is as described above, and the device (10) is preferably incorporated in a server device of a search site in the Internet such as Yahoo! (registered trademark) or Google (registered trademark), for example. In general, many of viewers motivated to search the advertisement contents upon seeing the CM make an access to the search site. Thus, by transmitting the advertisement relating to the present invention in a banner column or the like on the search site, the advertisement can be presented to the users the most effectively.

Another merit in displaying the advertisement on the search site is that when the public who recognized the CM through mass media visits the search site, an advertisement such as a banner with associated advertisement contents is displayed and recognition or involvement with the CM or brand is increased for a longer period than the unit of minute or hour during which the CM is broadcast, that is, the unit of day, week or month. Advertisements are preferably transmitted to the public through a plurality of paths, and even viewers who do not see or recognize the CM increase the recognition of the product by the advertisement in a banner, and if the CM reaches the viewers in that state, larger advertisement effectiveness can be exerted.

Also, those who saw the CM in the banner can be surely led to the homepage of the target product. For advertisers, it is preferable that the viewers who saw the CM access their own web pages, and the banner advertisements in the search site have an important meaning.

Similarly, the device (10) can be incorporated in a server device of a goods sales site (Rakuten (registered trademark), for example) selling the goods. In this configuration, when the viewers saw the CM and started a purchasing activity, it is preferable that the viewers are directly led to the web page of the goods or a purchase page without competitors' goods which could be examined for purchase at the site or outflow to other goods, and transmission of the banner advertisements and the like has an extremely high effect from the viewpoint of advertisement effectiveness.

Other than the configuration to be incorporated in the search site server or goods sales site server, there can be a configuration in which image data or the like as the advertisement data is transmitted to regions such as predetermined banner advertisement columns, text advertisement columns and the like in each server in conjunction with these existing servers or a configuration in which the image data or the like stored in the device as a link from the regions is transmitted to a user terminal device.

### BRIEF DESCRIPTION OF THE DRAWINGS

FIG. 1 is an entire diagram of a system in which a network advertisement transmitting device according to the present invention is installed.

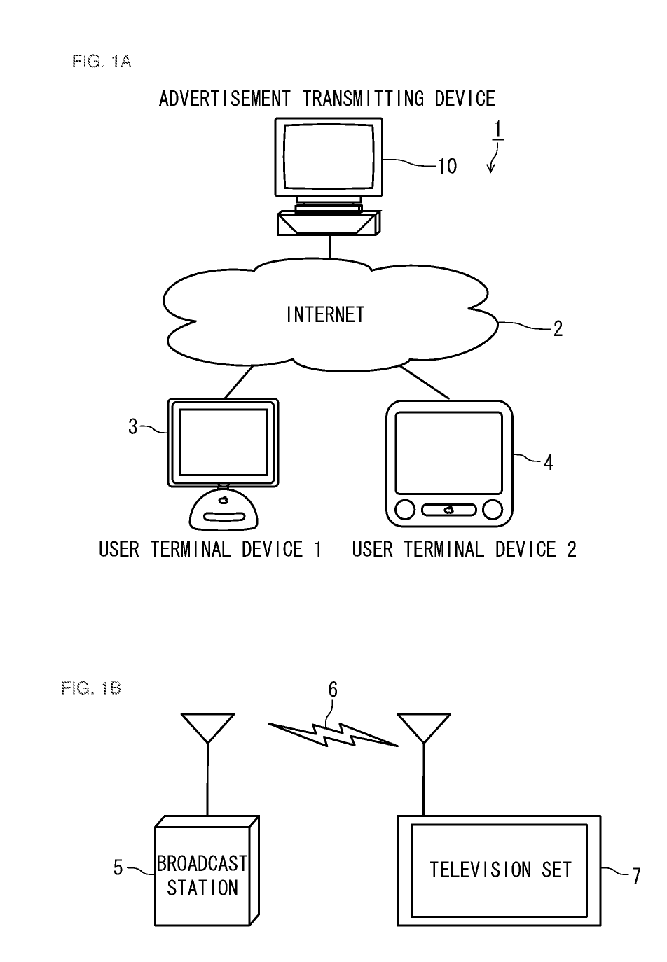

FIG. 2 is a configuration diagram of the network advertisement transmitting device according to the present invention.

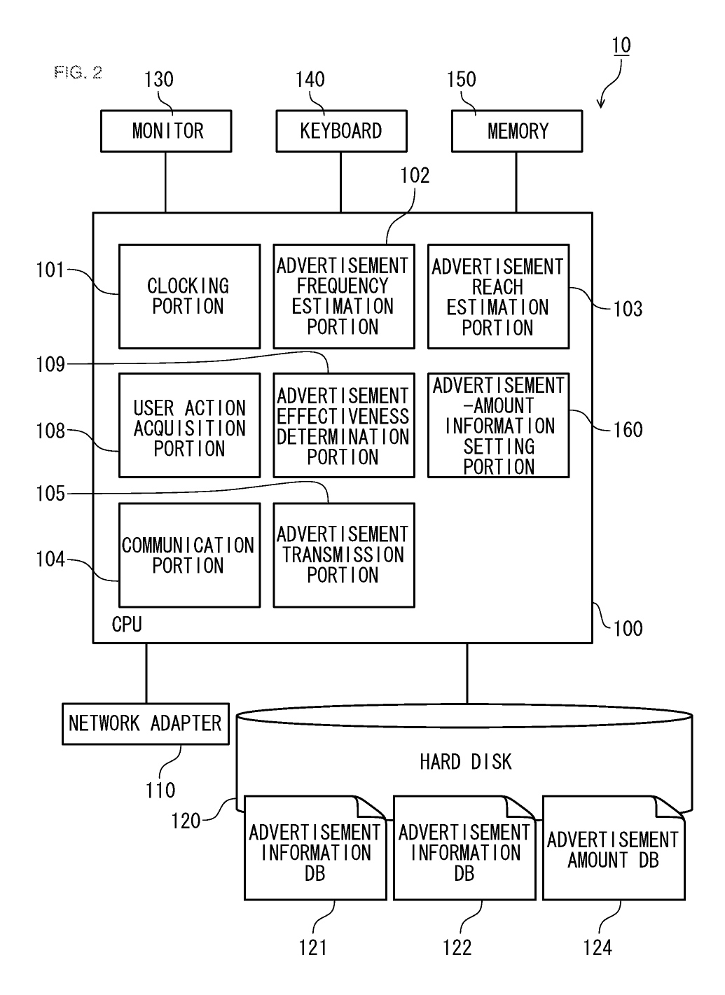

FIG. 3 is a processing flowchart (first embodiment) of a network transmitting method according to the present invention.

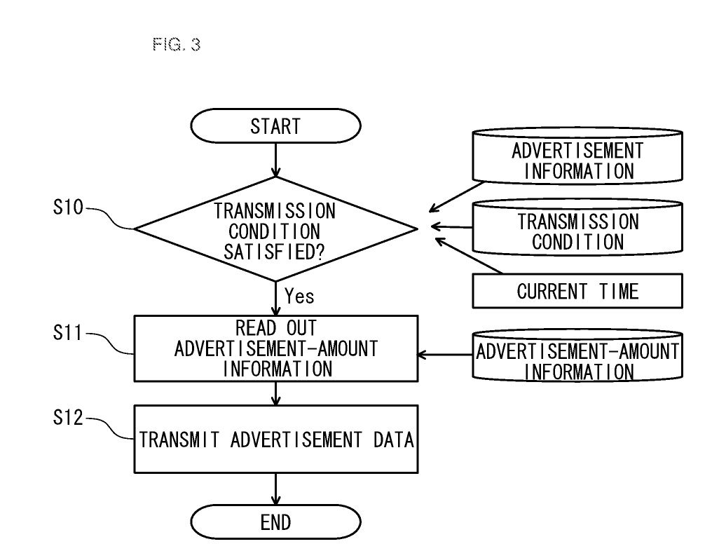

FIG. 4 is a processing flowchart (third embodiment) of advertisement-amount information setting according to the present invention.

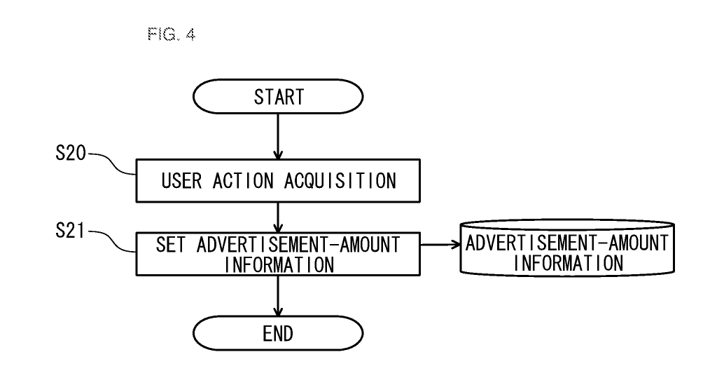

FIG. 5 is a processing flowchart (fourth embodiment) of the advertisement-amount information setting according to the present invention.

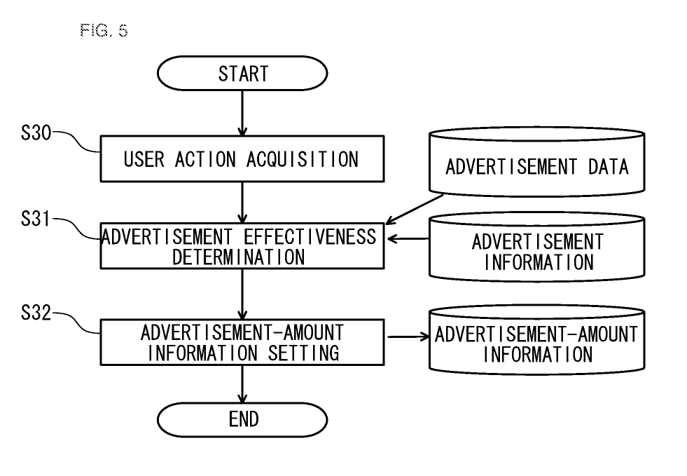

FIG. 6 are explanatory diagrams on the advertisement-amount information setting in the present invention.

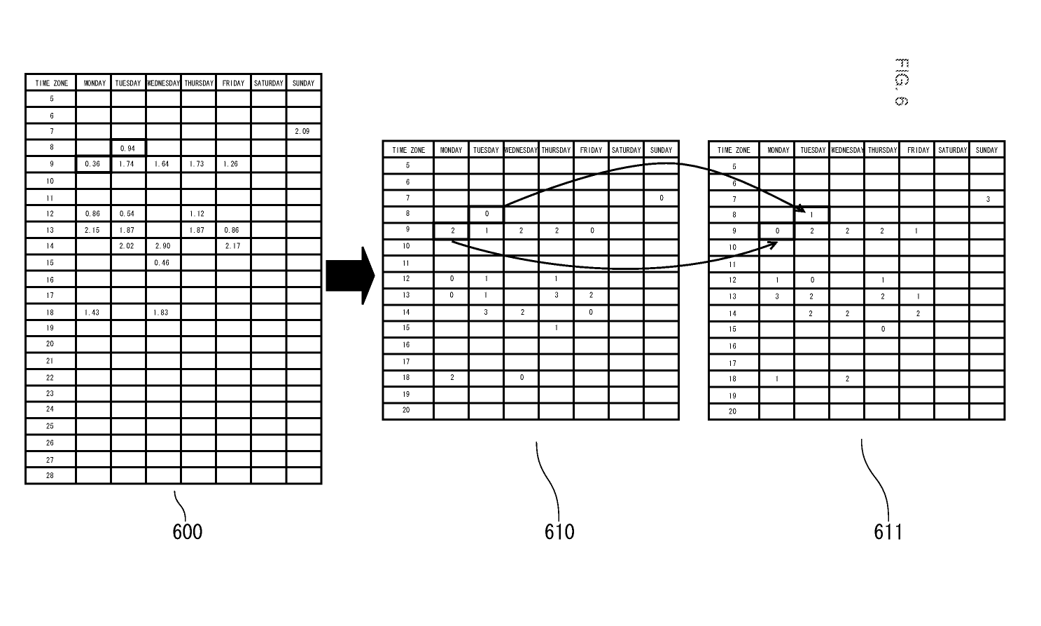

FIG. 7 are explanatory diagrams of patterns of advertisement-amount information in the present invention.

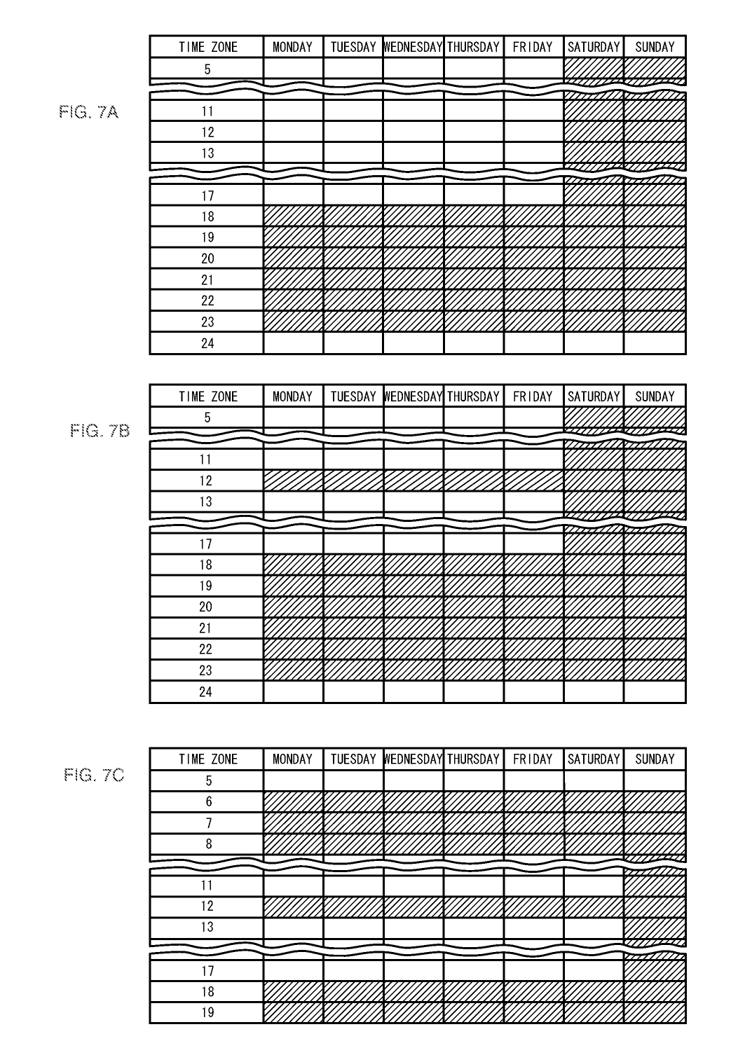

FIG. 8 are explanatory diagrams on setting of advertisement-amount information in plural media in the present invention.

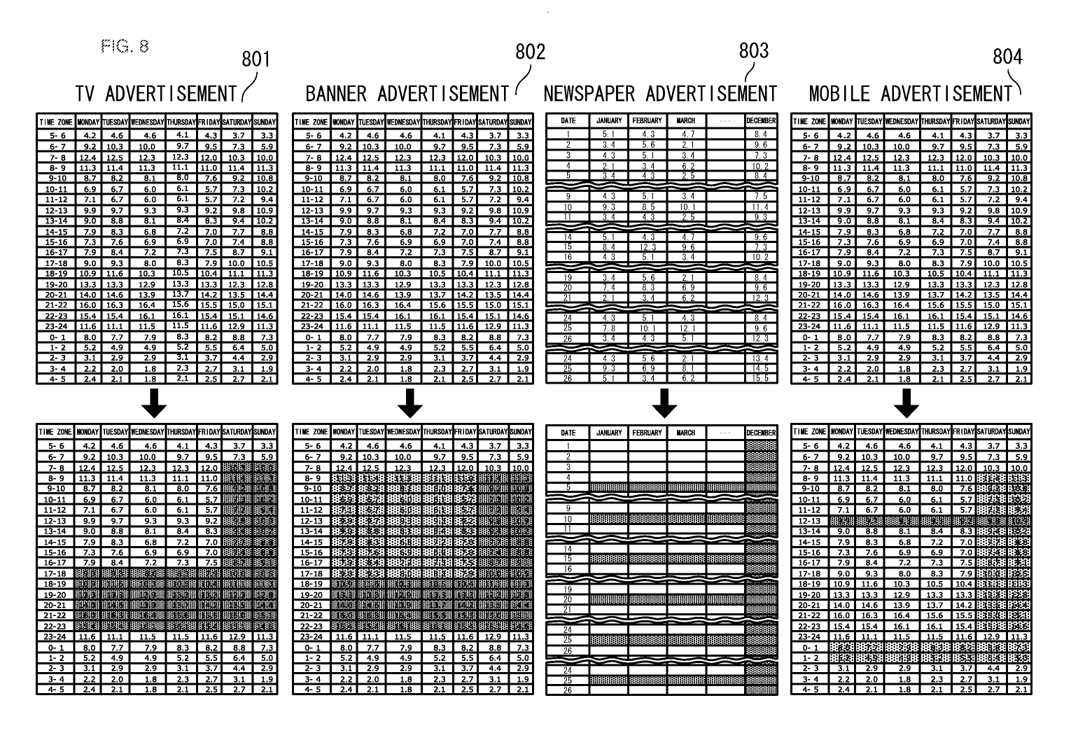

FIG. 9 is a processing flowchart (sixth embodiment) of the network advertisement transmitting method according to the present invention.

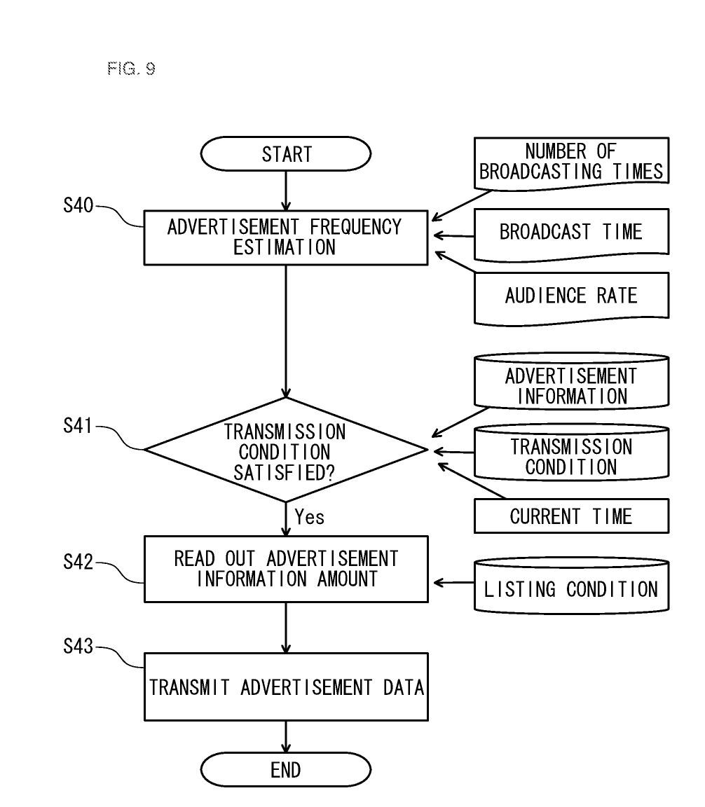

FIG. 10 is a processing flowchart (seventh embodiment) of the network advertisement transmitting method according to the present invention.

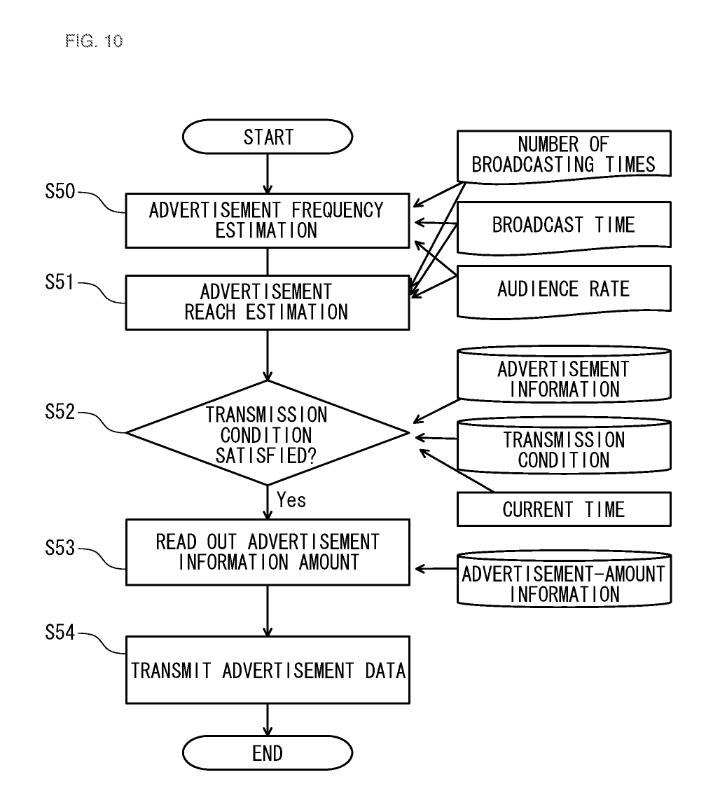

FIG. 11 is a flowchart (eighth embodiment) of the network advertisement transmitting method according to the present invention.

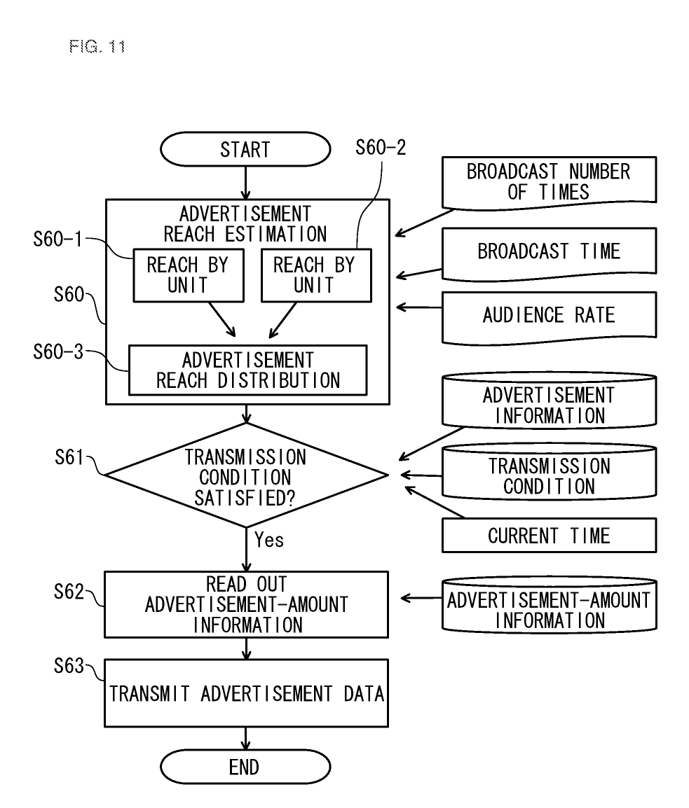

FIG. 12 is a diagram for explaining a calculation method in an advertisement frequency estimation portion.

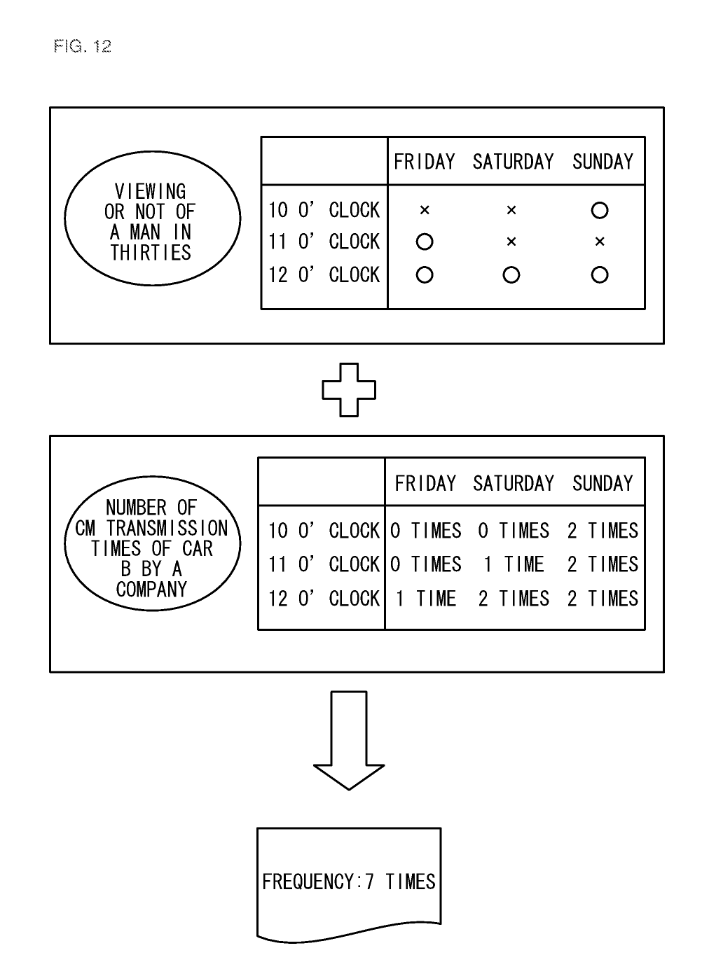

FIG. 13 is a diagram for explaining the calculation method (seventh embodiment) in the advertisement reach estimation portion.

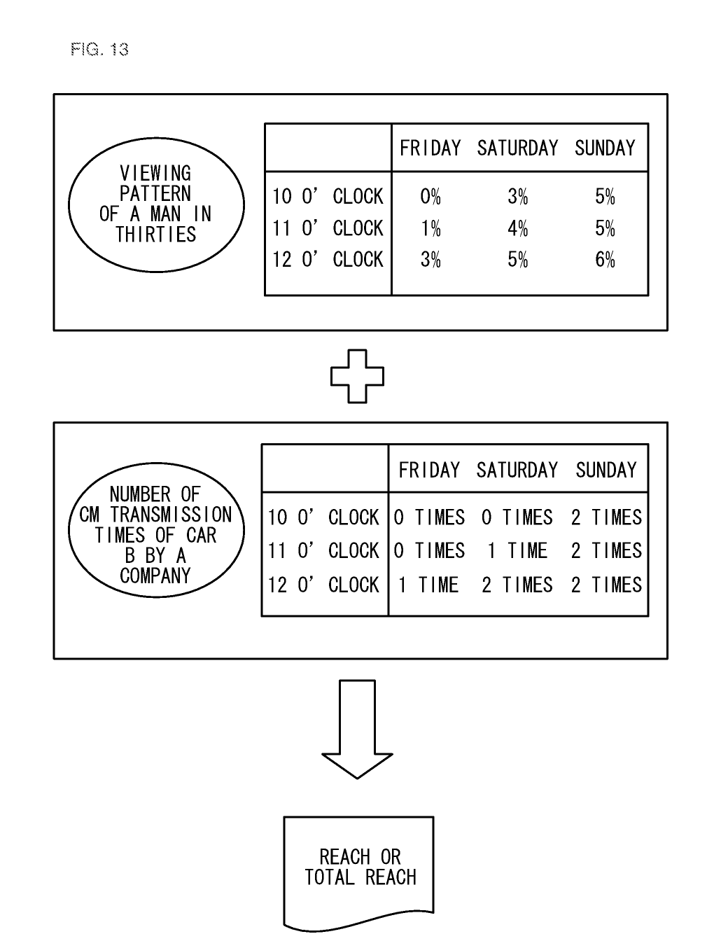

FIG. 14 is a diagram for explaining the calculation method (eighth embodiment) in the advertisement reach estimation portion.

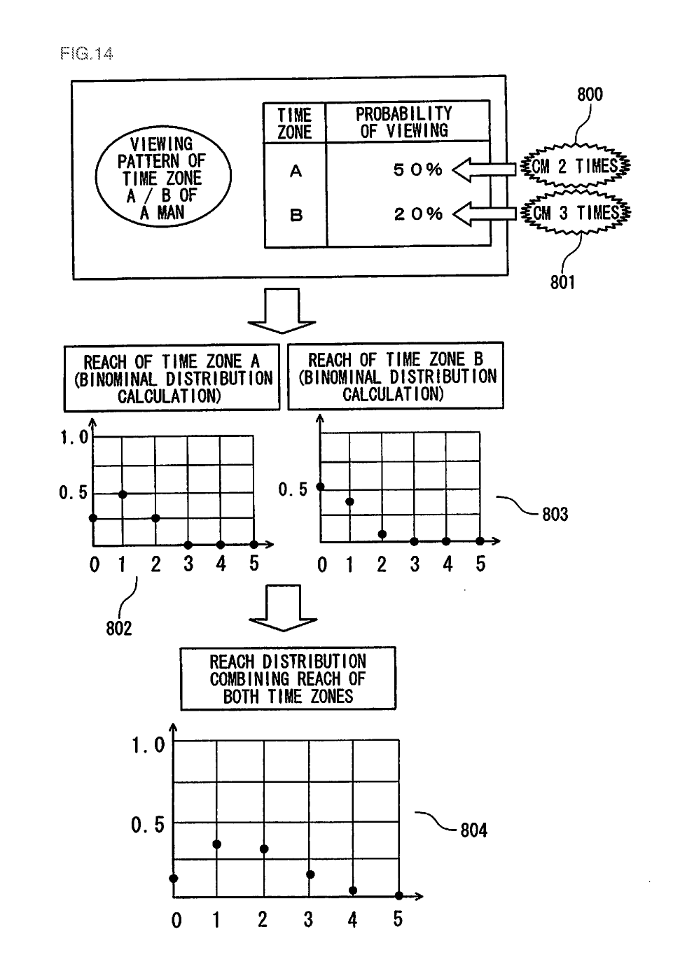

FIG. 15 is a graph illustrating effective advertisement frequency distribution.

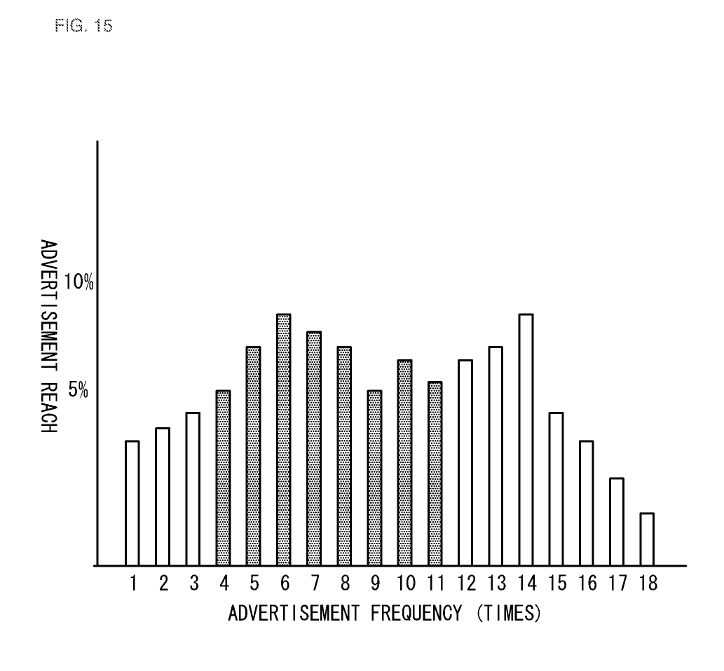

FIG. 16 is an image of a screen for explaining a position of an advertisement display.

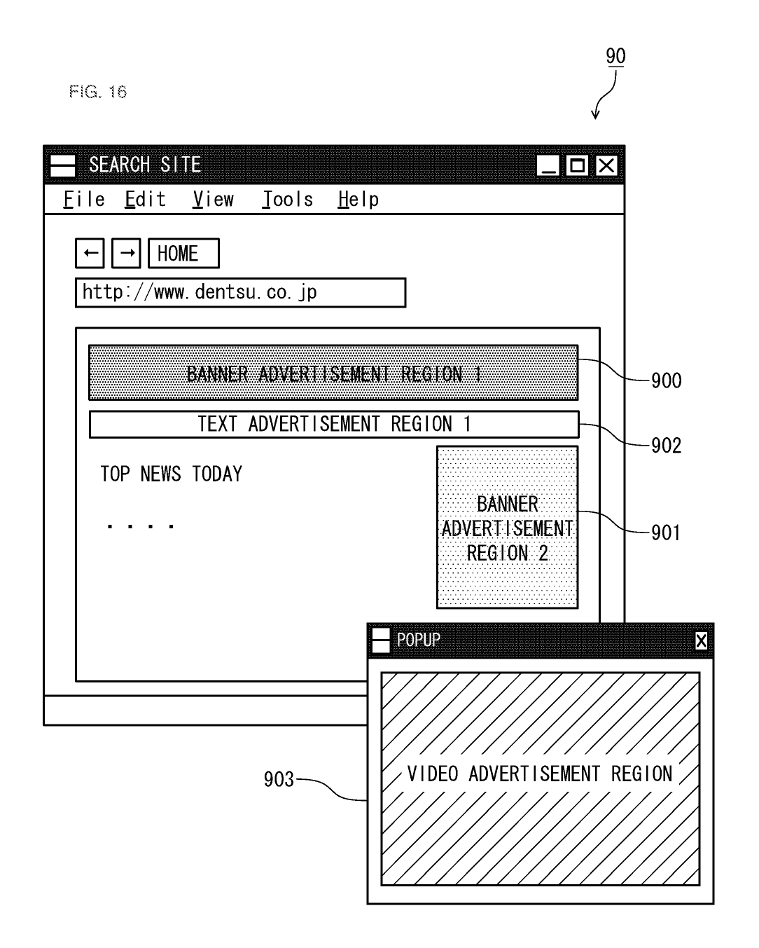

FIG. 17 is an image of a screen for explaining a user action.

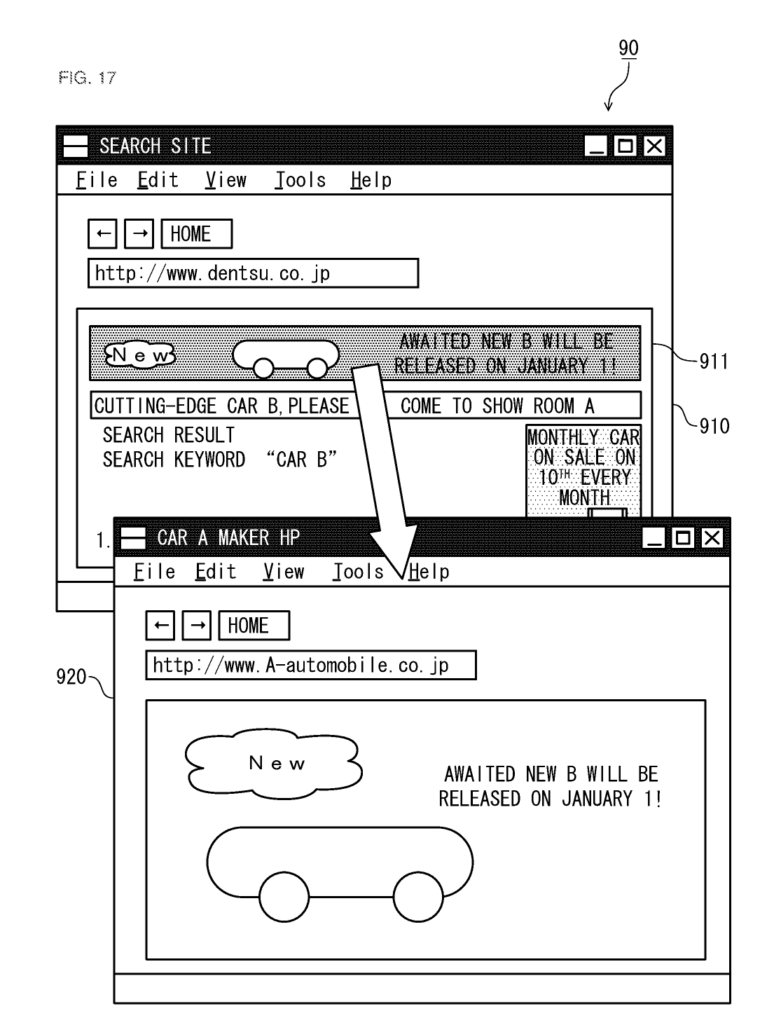

### EXPLANATION OF REFERENCE NUMERALS

10 network advertisement transmitting device
100 CPU
101 clocking portion
102 advertisement frequency estimation portion
103 advertisement reach estimation portion
104 communication portion
105 advertisement transmission portion
108 user action acquisition portion
109 advertisement effectiveness determination portion
160 advertisement-amount information setting portion
110 network adapter
120 hard disk
121 advertisement information database
122 advertisement condition database
124 advertisement-amount database
130 monitor
140 keyboard
150 memory

1. A network advertisement transmitting device connected to a user terminal device through a network and capable of transmitting advertisement data outputted at the user terminal, comprising:
an advertisement-amount database storing advertisement-amount information in which an advertisement amount relating to at least either of the number of times and time for outputting the advertisement data is set for time and date for output in storage means;
an advertisement information database storing in storage means advertisement information relating to at least advertisement contents and broadcast time;
an advertisement condition database storing in the storage means corresponding advertisement data and transmission conditions thereof according to the advertisement contents, the transmission conditions including at least a conditional relationship between the advertisement information and the current time; and
advertisement transmitting means for transmitting the advertisement data from the advertisement condition database to the user terminal device through the network according to the advertisement amount information if the current time obtained from clocking means satisfies the transmission conditions.

2. The network advertisement transmitting device according to claim 1,
the advertisement information database in the network advertisement transmitting device stores information relating to advertisements delivered on wired or wireless broadcast media intended to be directly received by the public.

3. The network advertisement transmitting device according to claim 2, wherein the broadcast programs are broadcast shows of news, sports, performance, entertainment, discussion and the like.

4. The network advertisement transmitting device according to claim 3, further comprising goods information extracting means for extracting information on goods relating to goods or service from the broadcast contents of the broadcast program if the broadcast program is a broadcast show so that the extracted information is used as advertisement content, the broadcast information at that time as advertisement information, and the broadcast information database at that time as an advertisement information database.

5. The network advertisement transmitting device according to any one of claims 1 to 3, wherein a case in which the broadcast program is an advertisement is included, and in that case, the broadcast content is the advertisement content, the broadcast information is advertisement information, and the broadcast information database is the advertisement information database.

6. The network advertisement transmitting device according to any one of claims 1 to 5, further comprising:
an advertisement information database storing in the storage means advertisement information relating to at least advertisement content and issued dates of advertisements placed in paper media including newspaper or magazine or advertisement media for the public including transport advertisements or outdoor advertisements;
an advertisement condition database storing corresponding advertisement data and transmission conditions thereof in the storage means according to the advertisement contents, the transmission conditions including at least a condition relationship between the advertisement information and the current time; and
advertisement transmitting means for transmitting the advertisement data from the advertisement condition database to the user terminal device through the network according to the advertisement-amount information if the current time obtained from the clocking means satisfies the transmission conditions.

7. The network advertisement transmitting device according to any one of claims 1 to 6, wherein the device corresponds to any output modes of two or more types of output modes in the user terminal device, two or more types of user terminal devices or two or more types of networks; and
the advertisement-amount information is stored in the advertisement-amount database for each output mode with respect to the date for output.

8. The network advertisement transmitting device according to any one of claims 1 to 7, further comprising:
user action acquisition means for acquiring user action information for the advertisement data;
advertisement effectiveness determining means for determining effectiveness of the advertisement from the action information and the advertisement data; and
advertisement-amount information setting means for setting the advertisement- amount information according to the determined result.

9. The network advertisement transmitting device according to any one of claims 1 to 8, further comprising an advertisement-amount pattern database storing in the storage means a plurality of patterns prepared in advance for the advertisement amounts with respect to the date for output, wherein
the advertisement-amount information setting means selects any one of the plurality of patterns and sets the advertisement-amount information according to the determined result of the advertisement effectiveness.

10. The network advertisement transmitting device according to any one of claims 6 to 9, wherein the advertisement-amount information setting means sets the advertisement-amount information for mass media advertisements in at least any one of the broadcast media, paper media including newspaper or magazine or advertisement media for the public including transport advertisement or outdoor advertisement.

11. The network advertisement transmitting device according to any one of claims 2 to 10, wherein the broadcast media is TV broadcast or radio broadcast.

12. The network advertisement transmitting device according to any one of claims 2 to 10, wherein the broadcast media utilizes a network communication path and is at least either one of image or video delivery or sound delivery.

13. The network advertisement transmitting device according to any one of claims 1 to 12, wherein the advertisement data is at least any one of text data, image data, video data or sound data constituting video advertisement, banner advertisement or text advertisement.

14. The network advertisement transmitting device according to any one of claims 1 to 13, wherein the network is the Internet.

15. The network advertisement transmitting device according to any one of claims 1 to 13, wherein the network is a cellular phone line or PHS phone line and the user terminal device is a phone terminal thereof.

16. A network advertisement transmitting method of a computer in a network advertisement transmitting device connected to a user terminal device through a network and capable of transmitting advertisement data outputted at the user terminal device, comprising advance prepared:
advertisement-amount database storing in storage means advertisement-amount information in which an advertisement amount relating to at least either of the number of times and time for outputting the advertisement data is set for time and date for output
advertisement information database storing in storage means broadcast information relating to at least broadcast contents and broadcast time; and
an advertisement condition database storing in the storage means corresponding advertisement data and transmission conditions thereof according to the broadcast contents, the transmission conditions including at least a conditional relationship between the broadcast information and the current time; wherein
an advertisement transmission step is provided in which the advertisement transmitting means of a computer transmits. in accordance with the advertisement amount information, advertisement data from the advertisement condition database to the user terminal device via the network, if the current time obtained from clocking means satisfies the transmission conditions.

17. The network advertisement transmitting method according to claim 16, wherein
the advertisement information database in the network advertisement transmitting device stores information relating to advertisements delivered on wired or wireless broadcast media intended to be directly received by the public.

18. The network advertisement transmitting method according to claim 17, wherein the broadcast programs are broadcast shows of news, sports, performance, entertainment, discussion and the like.

19. The network advertisement transmitting method according to claim 18, further comprising
a goods information extracting step in which goods information extracting means of a computer extracts information on goods relating to an article or service from the broadcast contents of the broadcast show before the advertisement transmission step, if the broadcast program is a broadcast show, wherein
the extracted information is used as advertisement content, the broadcast information at that time as advertisement information, and the broadcast information database at that time as an advertisement information database.

20. The network advertisement transmitting method according to any one of claims 17 to 19, wherein a case in which the broadcast program is an advertisement is included, and in that case, the broadcast contents are advertisement contents, the broadcast information is advertisement information, and the broadcast information database is the advertisement information database.

21. The network advertisement transmitting method according to claim 19 or 20, further comprising, in the network advertisement transmitting method of a computer advance prepared:
advertisement information database storing in storage means advertisement information relating to at least advertisement contents and issued dates out of advertisements placed on paper media including newspaper or magazine or advertisement media for the public including transport advertisements or outdoor advertisements; and
advertisement condition database storing corresponding advertisement data and transmission conditions thereof in the storage means according to the advertisement contents, the transmission conditions including at least a condition relationship between the advertisement information and the current time, wherein
if the current time obtained from the clocking means satisfies the transmission conditions in the advertisement transmission step, the advertisement data is transmitted from the advertisement condition database to the user terminal device through the network according to the advertisement-amount information.

22. The network advertisement transmitting method according to any one of claims 16 to 21, wherein the network advertisement transmitting method of a computer corresponds to any of output modes of two types or more of output modes in the user terminal device, two or more types of user terminal devices or two or more types of the networks, and the advertisement-amount information is stored in the advertisement-amount database for each output mode with respect to the date for output.

23. The network advertisement transmitting method according to any one of claims 16 to 22, wherein, in. the network advertisement transmitting method of a computer, user action acquisition means of a computer has a user action acquisition step for acquiring user action information relating to the advertisement data;
advertisement effectiveness determining means of a computer has an advertisement effectiveness determining step for determining effectiveness of the advertisement from the action information and the advertisement data; and
advertisement-amount information setting means of a computer has an advertisement-amount information setting step for setting the advertisement-amount information according to the determined result.

24. The network advertisement transmitting method according to any one of claims 16 to 23, further comprising, in the network advertisement transmitting method of a computer an advance prepared advertisement-amount pattern database storing a plurality of patterns prepared in advance for the advertisement amounts with respect to the date for output in the storage means, wherein
in the advertisement-amount information setting step, the advertisement-amount information is set by selecting any one of the plurality of patterns according to the determined result of the advertisement effectiveness.

25. The network advertisement transmitting method according to any one of claims 16 to 24, wherein, in the advertisement-amount information setting step, the advertisement-amount information for mass media advertisements is also set in at least any one of the broadcast media, paper media including newspaper or magazine or advertisement media for the public including transport or outdoor advertisements.

26. The network advertisement transmitting method according to any one of claims 17 to 25, wherein the broadcast media is TV broadcast or radio broadcast.

27. The network advertisement transmitting method according to any one of claim 17 or 25, wherein the broadcast media is at least either one of image or video delivery or sound delivery using a network communication path.

28. The network advertisement transmitting method according to any one of claims 16 to 27, wherein the advertisement data is at least any one of text data, image data, video data or sound data constituting video advertisement, banner advertisement or text advertisement.

29. The network advertisement transmitting method according to any one of claims 13 to 28, wherein the network is the Internet.

30. The network advertisement transmitting method according to any one of claim 13 or 28, wherein the network is a cellular phone line or PHS phone line and the user terminal device may be a phone terminal thereof.
